(19) United States
(12) Patent Application Publication
(10) Pub. No.: US 2002/0108644 A1
(43) Pub. Date: Aug. 15, 2002

(54) Steerable delivery system

(76) Inventors: David J. Hoadley, Lexington, MA (US); Thieu Q. Truong, North Easton, MA (US); Gordon Lewis, Needham, MA (US)

Correspondence Address: Iandiorio & Teska, 260 Bear Hill Road, Waltham, MA, 02451-1018, US

(21) Appl. No.: 10/034,297

(22) Filed: Dec. 21, 2001

Related U.S. Application Data
(60) Provisional application No. 60/257,448, filed on Dec. 21, 2000.

(51) Int. Cl. B08B 3/02

(52) U.S. Cl. 134/172

(57) ABSTRACT

A steerable delivery system with a steerable section rigid along its longitudinal axis and flexible in at least one direction off-axis and a follower section rigid along its longitudinal axis and flexible in at least the same direction as the steerable section, both the steerable section and the follower section advanceable in the direction of the longitudinal axis. A pivot member is disposed between a proximal end of the steerable section and a distal end of the follower section. A steering mechanism is located on the proximal end of the follower section for actively flexing the steerable section at the pivot member, and steering the steerable section in said one direction, the follower section flexing to follow the steerable section.

### RELATED APPLICATIONS

This application claims priority from provisional application Serial No. 60/257,448 filed Dec. 21, 2000.

### FIELD OF THE INVENTION

This invention relates to the field of flexible lances and more generally to a steerable delivery system useful in situ for the inspection, repair, and/or maintenance of various machinery, systems, devices, and housings.

### BACKGROUND OF THE INVENTION

Steam and gas turbines, the steam generators of nuclear power plants, and many other types of machinery and systems have extremely close internal confines, difficult to access geometries, and tightly spaced components which must be inspected, repaired and/or maintained. For example, the rotor and stator blades of compressors are spaced closely together and offset from each other along the longitudinal axis of the compressor defining a tortuous path between the blades.

Disassembly of such machinery or systems for inspection, cleaning, repair, or maintenance purposes (e.g., to inspect, clean and repair the rotor and stator blades of a compressor) is costly and results in expensive down time. Moreover, re-assembly can result in performance problems with the machinery or system.

Therefore, those skilled in the art have long attempted to devise equipment versatile enough to be delivered into and, just as importantly, extracted from within various types of machinery despite the close confines therein and the difficult to access geometries defined by the internal components thereof.

In one example, U.S. Pat. No. 5,036,871, incorporated herein by this reference, discloses a rigid support rail disposed in the blow down lane of a pressurized water reactor steam generator through a handhole. A rigid transporter is suspended for locomotion along the support rail. A flexible lance extends through and is guided by the rigid transporter and can be driven forward and backward to observe and/or clean sludge deposits within the tube bundle of the steam generator. The tubes of the tube bundle are formed in an array and thus the flexible lance is guided only in a straight line between two rows of tubes.

Such a system, however, is not adequate for the inspection, maintenance, or repair of other types of machinery because the flexible lance itself cannot be steered and because other types of machinery are not configured to accept the rigid support rail and/or a rigid transporter therein. For example, the blades inside a gas or steam turbine engine would quickly block advancement of the flexible lance. Moreover, such machinery comprises components so densely packed that a rigid support rail and/or a rigid transporter could not be deployed therein at all. And, unlike a steam generator, turbines do not have guide paths such as blow down lanes and tube arrays for guiding the flexible lance of the '871 patent.

Related prior art U.S. Pat. No. 5,286,154, also incorporated herein by this reference, discloses the same type of lance system as the '871 patent, including a transport rail and transporter, but adds two retrievers each disposed on the end of an actuating cable which extends through the lance. Although the actuating cables are stated to be steerable to some extent, they do not steer the flexible lance. Thus the design of the '154 patent suffers from the same limitations as the design of the '871 patent. Finally, even with respect to steam generators, the design of the '871 patent is only useful for the area closely proximate the blow down lane.

### BRIEF SUMMARY OF THE INVENTION

It is therefore an object of this invention to provide a steerable system useful for in situ inspection, maintenance, and/or repair of various types of machinery and systems including, but not limited to, gas turbines, steam turbines, and the like with difficult to access internal geometries.

It is a further object of this invention to provide such a system which is fairly simple in design and easy to manufacture and use.

It is a further object of this invention to provide such a steerable system which does not typically require a rigid transporter or a support rail.

It is a further object of this invention to provide a remotely operated steerable delivery system.

It is a further object of this invention to provide such a system which can be extended many (e.g., 10 or more) feet into complex machinery irrespective of the internal geometry thereof.

It is a further object of this invention to provide such a system which can be steered between and around even the offset and closely adjacent blades of a compressor or turbine.

It is a further object of this invention to provide such a system which is easily retracted from within machinery with complex internal geometries.

The invention results from the realization that a steerable delivery system which typically does not require a support rail or a transporter and which can be deployed deep within machinery even with complex internal geometries is effected by the combination of: a) an end section rigid along its longitudinal axis so it can be urged forward, but flexible in one or more directions off axis and remotely steerable to advance between and around various internal machinery components; b) a follower section located behind the steerable section also rigid along its longitudinal axis and flexible off-axis; and c) a pivot mechanism or member which couples the steerable section to the follower section such that the steerable section pivots with respect to the pivot member. The follower section then follows the steerable section as it is advanced within various types of machinery and steered about the internal components thereof.

In this way, even the rotor and stator blades deep within a turbine or compressor and far removed from an access port can be inspected, cleaned, and/or repaired since both the steerable section and the follower section are advanced forward, the steerable section steered between and about the blades, with the follower section advanceable forward to follow the path of the steerable section. Moreover, there is no need for a support rail or a transporter or the like which can not typically be received within turbine or generator housings.

This invention features a steerable delivery system comprising a steerable section rigid along its longitudinal axis and flexible in at least one direction off-axis, a follower section rigid along its longitudinal axis and flexible in at least the same direction as the steerable section, both the steerable section and the follower section advanceable in the direction of the longitudinal axis; a pivot member disposed between a proximal end of the steerable section and a distal end of the follower section, and a steering mechanism on the proximal end of the follower section for actively flexing the steerable section at the pivot member, and steering the steerable section in said one direction, the follower section flexing to follow the steerable section.

In one preferred embodiment the distal end of the steerable section includes an end effector coupled thereto. The steerable section may include a plurality of abutting links and each steerable section link may include a plurality of cables therethrough terminating at a distal end of the steerable section for steering the steerable section. Typically, each steerable section link also includes at least one orifice for receiving a conduit, a transmission line, or a shaft therethrough. In one example, each steerable section link includes upper inner and outer opposing faces, lower inner and outer opposing faces, and a central section interconnecting the upper opposing faces with the lower opposing faces. The inner faces of each steerable section link abut the outer faces of each adjacent steerable section link. In one embodiment, there are four steer steering cables. Each upper and lower face of each steerable section link may include two steering cables extending slideably therethrough and terminating on one end at a distal end of the steerable section, passing slideably through the pivot member and the follower section, and terminating at an opposite end at the steering mechanism.

The follower section may be a flexible conduit but may also include a plurality of abutting links and each follower section link also includes the steering cables passing therethrough and terminating at a distal end of the steerable section for steering the steerable section. Each follower section link also typically includes at least one tie cable extending therethrough terminating at one end at the pivot member and terminating at the other end at the steering mechanism. The follower section links may also include at least one orifice for receiving a conduit, a transmission line, or a shaft therethrough. The follower section links may include upper inner and outer opposing faces, lower inner and outer opposing faces, and a central section interconnecting the upper opposing faces with the lower opposing faces. The inner faces of each follower section link abut the outer faces of each said adjacent follower section link. The upper and lower faces of the follower section links typically include at least one steering cable extending slideably therethrough and terminating on one end at a distal end of the steerable section, passing slideably through the pivot member, and terminating at an opposite end at the steering mechanism. In addition, the upper and lower faces of each follower section link typically also include at least one tie cable extending therethrough terminating on one end at the pivot member and terminating on the other end at the steering mechanism. The steerable section links and the follower section links preferably include upper and lower faces each having opposing tapered sections. The opposing tapered sections may meet at a point or may form a flat surface of small or large dimension.

In one preferred embodiment, the steerable section and the follower section both include a plurality of abutting links, wherein all of the links include at least one steering cable passing slideably therethrough, the steering cable fixed on one end at a distal end of the steerable section and fixed on the opposite end at the steering mechanism, and further wherein at least the links of the follower section also include at least on tie cable passing therethrough, the tie cable fixed on one end at the pivot member and fixed on an opposite end at the steering mechanism.

In another example, each steerable section link includes at least one ball and at least one socket wherein the ball of one link is pivotably received in the socket of an adjacent link. Each steerable section link may include two opposing outwardly extending balls and two opposing inwardly extending sockets. Typically, the sockets are offset 90° from the balls. The steerable section links may include a tube shaped wall having outwardly extending balls on one end thereof and inwardly extending sockets in an opposite end thereof. In addition, or alternatively, the follower section links include at least one ball and at least one socket and wherein the ball of one link is pivotably received in the socket of an adjacent link. In one example, each follower section link includes two opposing outwardly extending balls and two opposing inwardly extending sockets. The sockets are typically offset 90° from the balls. Each follower section link may include a tube shaped wall having outwardly extending balls on one end thereof and inwardly extending sockets in an opposite end thereof.

The end effector may include an optical device, a nozzle, and/or a tool. Typically, the length of the steerable section is much less than the length of the follower section. Also, the pivot member is usually connected to a distal end of the follower section.

This invention also features a steerable delivery system comprising a steerable section having a distal end effector and including a plurality of links, each link including an orifice therethrough for receiving a conduit, transmission line, or a shaft connected to the end effector, a follower section rigid along its longitudinal axis and flexible in an least one direction off-axis, a pivot mechanism disposed between a proximal end of the steerable section and a distal end of the follower section, the steerable section pivotable with respect to the pivot mechanism, a steering mechanism on a proximal end of the follower section and at least one steering cable extending from the steering mechanism through the follower section, the pivot mechanism, and the links of the steerable section and terminating at the distal end of the steerable section. In one example, the follower section also includes a plurality of links and further included is a tie cable extending from the steering mechanism, through the links of the follower section, and terminating at the pivot mechanism.

This invention also features a steerable delivery system comprising a steerable section having a distal end effector and including an orifice therethrough for receiving a conduit, transmission line, or a shaft, a follower section including a plurality of links and configured to be rigid along its longitudinal axis and flexible in an least one direction off-axis, a pivot mechanism disposed between the proximal end of the steerable section and the distal end of the follower section, the steerable section pivotable with respect to the pivot mechanism, a steering mechanism on the proximal end of the follower section, and at least one steering cable extending from the steering mechanism through the links of the follower section, the pivot mechanism, and the steerable section and terminating at the distal end of the steerable section. In one example, the steerable section also includes a plurality of links and there is a tie cable extending from the steering mechanism, through the links of the follower section, and terminating at the pivot mechanism.

### BRIEF DESCRIPTION OF THE DRAWINGS

Other objects, features and advantages will occur to those skilled in the art from the following description of a preferred embodiment and the accompanying drawings, in which:

FIG. 1 is a schematic three-dimensional view of a prior art flexible lance and drive system;

FIG. 2 is a schematic view of an in-bundle foreign object search and retrieval apparatus in accordance with the prior art;

FIG. 3 is schematic view of the distal end of the flexible lance portion of the in-bundle foreign object search and retrieval apparatus shown in FIG. 2;

FIG. 4 is a schematic depiction of the steerable delivery system of the subject invention;

FIG. 5 is a schematic exploded view showing two links which, in one embodiment, form a part of the steerable section of the steerable delivery system shown in FIG. 4;

FIG. 6 is a schematic partially exploded view showing, in one embodiment, two links of the follower section of the steerable delivery system shown in FIG. 4;

FIG. 7 is a top view showing the assembly of the links, steering cables, and tie cables in one embodiment of the steerable delivery system of the subject invention;

FIGS. 7A and 7B are top views of additional embodiments of the links of the steerable delivery system of the subject invention;

FIG. 8 is another schematic view of one embodiment of the steerable delivery system of the subject invention;

FIG. 9 is a view similar to FIG. 8 with the steerable section shown flexed in one direction;

FIG. 10 is another view showing how the steerable delivery system of the subject invention can be rotated and then the steerable section thereof flexed to bend in different directions;

FIG. 11 is a schematic view showing, in more detail, one embodiment of the steering mechanism of the steerable delivery system of this invention;

FIG. 12 is another view of the steering mechanism shown in FIG. 11;

FIG. 13 is a schematic view showing, in another embodiment, three pivoting links which may form a part of the steerable section and/or the follower section of the steerable delivery system of the subject invention shown in FIG. 4;

FIG. 14 is another schematic view of the pivoting links shown in FIG. 13;

FIG. 15 is a schematic view showing another example of pivotable links which may form the steerable section and/or the follower section of the of the steerable delivery system shown in FIG. 4;

FIG. 16 is a view showing the degrees of freedom possible for the steerable delivery system of the subject invention;

FIG. 17 is a cut-away view of a typical turbine which may be inspected, cleaned, or repaired using the steerable delivery system of the subject invention;

FIG. 18 is a view showing the rotor and the stator blades of the turbine shown in FIG. 17;

FIGS. 19-21 are schematic depictions showing the steerable delivery system of the subject invention deployed within a turbine, between, about and also around the individual blades thereof; and

FIG. 22 is a schematic view showing the use of the steerable delivery system of the subject invention deployed inside a metal clad bus.

### DISCLOSURE OF THE PREFERRED EMBODIMENT

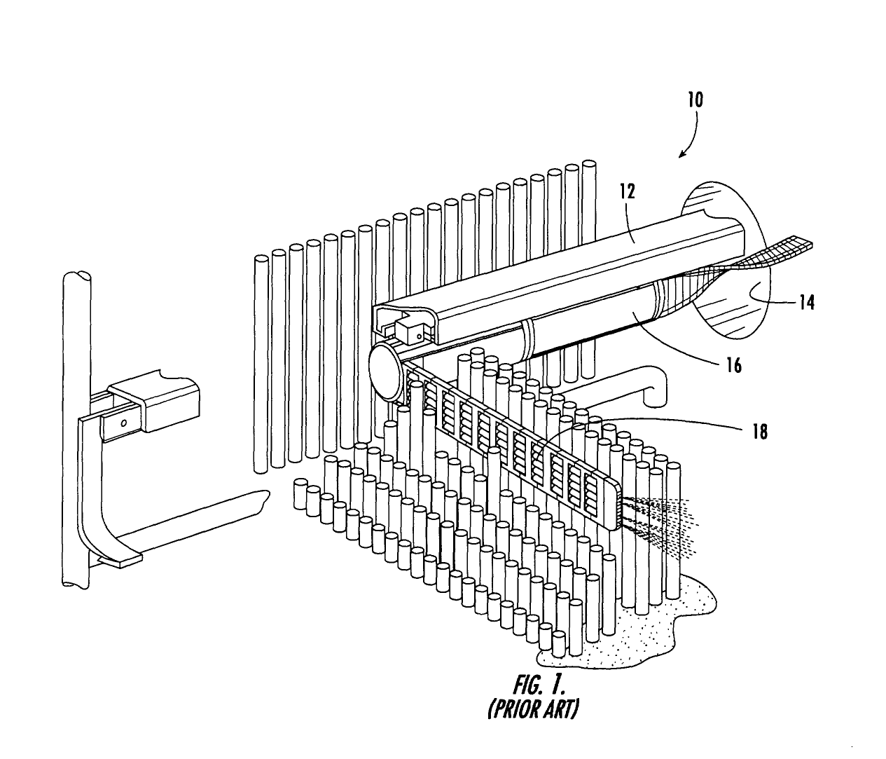

Flexible lance and drive system 10, FIG. 1, as disclosed in U.S. Pat. No. 5,036,871 to Ruggieri et al., includes rigid support rail 12 disposed in the blow down lane of a pressurized water reactor steam generator through manhole 14. Rigid transporter 16 is suspended for locomotion along support rail 12 and flexible lance 18 extends through transporter 16 and can be driven forward and backward to observe and/or clean sludge deposits within the tube bundle of the steam generator. The tubes of the tube bundle are formed in an array and thus flexible lance 18 is guided between two rows of tubes as shown. The system taught by U.S. Pat. No. 5,036,871, however, can not be used to inspect, maintain, or repair many other types of machinery because flexible lance 18 can not be steered and because other types of machinery are not configured to accept rigid support rail 12 or transporter 16 therein. For example, if deployed inside a gas or steam turbine engine, the rotor and stator vanes thereof would quickly block advancement of flexible lance 18 and, moreover, such machinery comprises components so densely packed that rigid support rail 12 and/or rigid transporter 16 could not be deployed therein.

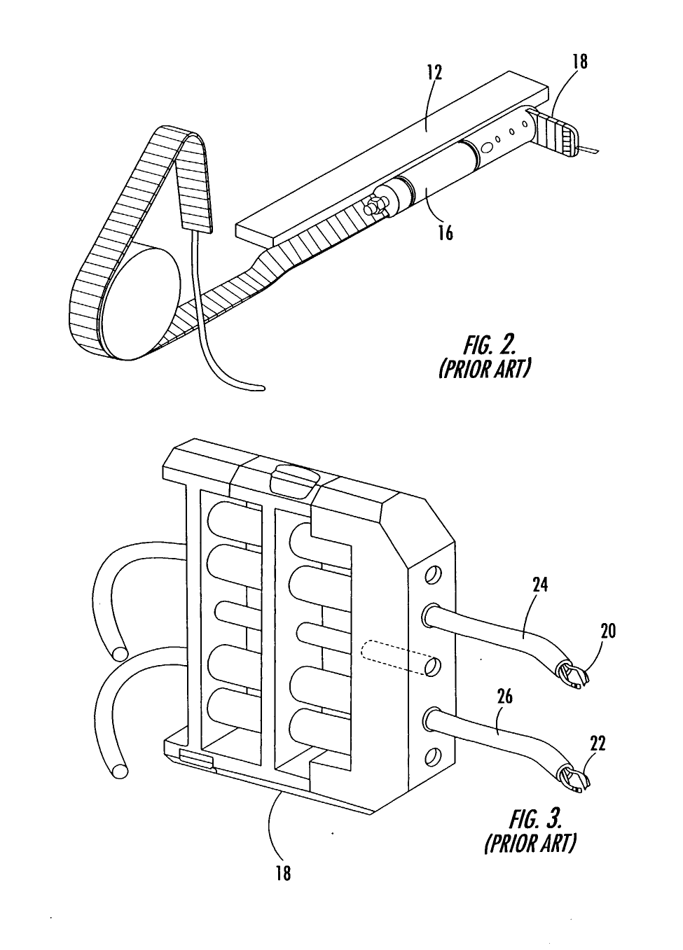

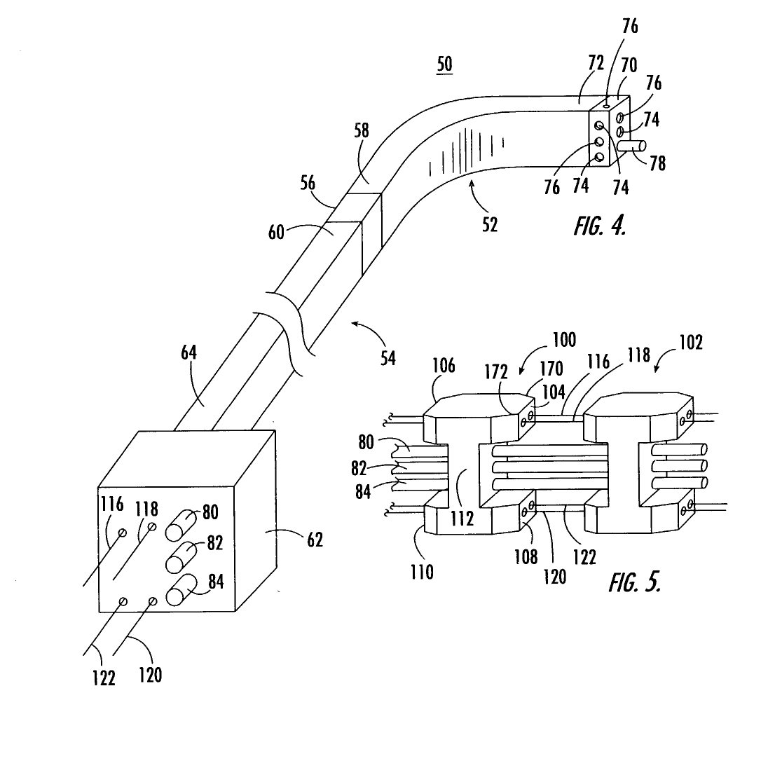

FIGS. 2-3 disclose the related prior art system of U.S. Pat. No. 5,286,154 to Jens et al. which, again, includes support rail 12, transporter 16, and flexible lance 18. Two retrievers 20 and 22 are added in this system, each disposed on the end of an actuating cable 24, 26, respectively. Although actuating cables 24 and 26 are stated to be steerable to some extent, they do not steer the flexible lance, and thus the flexible lance 18 is not steerable. Thus, this design suffers from the same limitations as the design of the '871 patent shown in FIG. 1 with respect to machinery other than pressurized water reactor steam generators. For example, if deployed inside a gas or steam turbine, the rotor and stator vanes thereof would quickly block any advancement of flexible lance 18, and many different types of machinery are not configured to accept rigid support rail 12 or rigid transporter 16 therein.

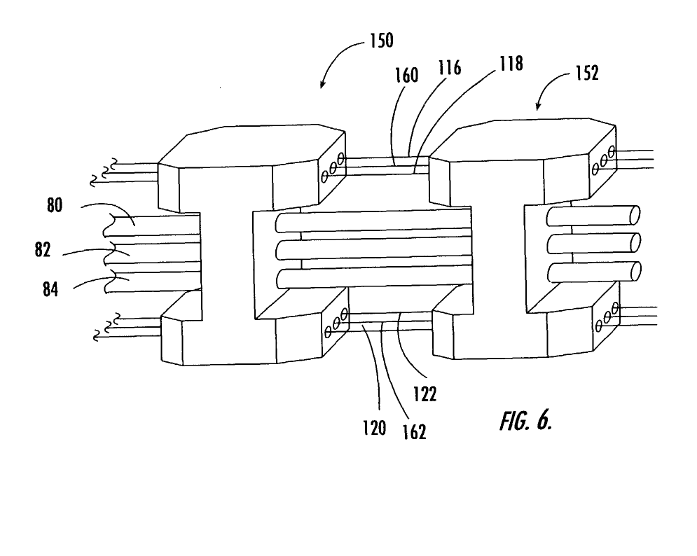

In contrast, lengthy steerable delivery system 50, FIG. 4, which typically has a relatively small cross-sectional area, does not usually require a rigid support rail or transporter for its operation. Instead, steerable delivery system 50 includes steerable section 52, follower section 54, and pivot mechanism or member 56 disposed between the proximal end 58 of steerable section 52 and typically coupled to the distal end 60 of follower section 54. Both steerable section 52 and follower section 54 are configured to be relatively rigid along the lengthy longitudinal axis of the device so that both section can be advanced forward. Steerable section 52 is further configured to be flexible in at least one direction off-axis as shown and also steerable in that direction to pivot with respect to follower section 54 at pivot member 56. The pivot point defined by pivot member 56 need not be supported by external components, and steerable section 52 flexes along its length between end effector 70 and pivot point 56 without the need for any support rails or transporters in contrast to the prior art systems of FIGS. 1-3.

Steering mechanism 62, FIG. 4 is typically located at the proximal end 64 of follower section 54 and is configured to steer steerable section 52, as discussed infra, to cause steerable section 52 to flex as shown in FIG. 4. In this way, as steerable section 52 is flexed under the control of steering mechanism 62 to pivot about pivot member 56, steerable section 52 can be steered and follower section 54 will follow steerable section 52 as both sections are advanced within machinery or within other devices or conduits.

End effector 70 is typically disposed on the distal end 72 of steerable section 52. End effector 70 may include one or more cleaning nozzles 74, one or more camera probes 76, and even tools such as tool 78 (e.g., a drill or a grinding bit). Other tools which can be a part of end effector 70 include ultrasonic probes, eddy current devices, die penetrant delivery nozzles, non-destructive evaluation tools and equipment, lights, graspers, and the like.

Typically, conduits (e.g., flexible fluid delivery conduits), electrical and/or optical transmission lines, and/or even flexible rotating shafts extend through or along follower section 54 and steerable section 52 and terminate at end effector 70 to provide fluid, and electrical and/or optical connections to the apparatus of end effector sub-assembly 70. In the example shown in FIG. 4, conduits 80, 82 and 84 are provided. Conduit 80 is for high-pressure fluid delivered to nozzles 74, conduit 82 is for optical fibers connected to camera probe 76, and conduit 84 includes the electrical connections which operate tool 78.

In other embodiments, however, there is no end effector sub-assembly per se: instead, steerable section 52 and follower section 54 are configured as a track or other transport mechanism to deploy separately configured tools and inspection equipment therealong deep within various types of machinery.

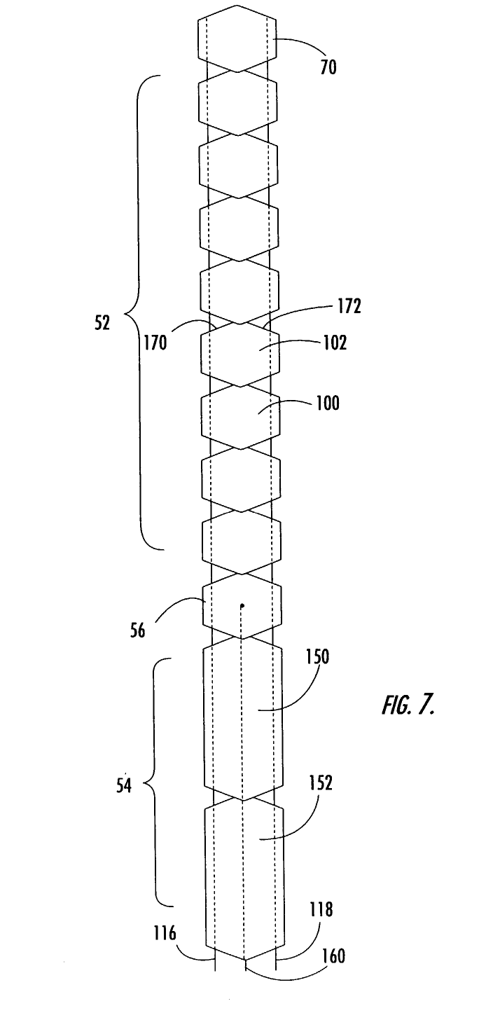

In the preferred embodiment, at least steerable section 52 includes a plurality of abutting links such as links 100, 102, FIG. 5. In one example, each link 100, 102 has a plurality of cables therethrough terminating at distal end 72 of steerable section 52, typically within end effector 70, for steering steerable section 52. Each link also includes orifices therethrough for receiving conduits, transmission lines, shafts, and the like as discussed above.

In the specific but non-limiting example of FIG. 5, link 100 includes upper inner 104 and outer 106 opposing faces, lower inner 108 and outer 110 opposing faces, and central section 112 interconnecting the upper opposing faces 104 and 106 and lower opposing faces 108 and 110. The inner faces of link 100 abut the outer faces of adjacent link 102. Steering cables 116 and 118 extend slideably in a parallel continuous fashion from outer opposing upper face 106, through the link, and out of upper inner face 104. Similarly, steering cables 120 and 122 extend slideably in a parallel continuous fashion from opposing lower outer face 110, through the link, and out lower inner face 108.

All of the steering cables preferably begin at steering mechanism 62, run slideably through follower section 54, slideably through pivot member 58, slideably through the links of steerable section 52 and terminate within end effector 70. By pulling on cables 118 and 120, steerable section 52 flexes in the direction shown in FIG. 4. Pulling on cables 116 and 122 results in steerable section 52 flexing in the opposite direction. The number and orientation of the various steering cables depends on the specific application and the number of degrees of freedom afforded steerable section 52.

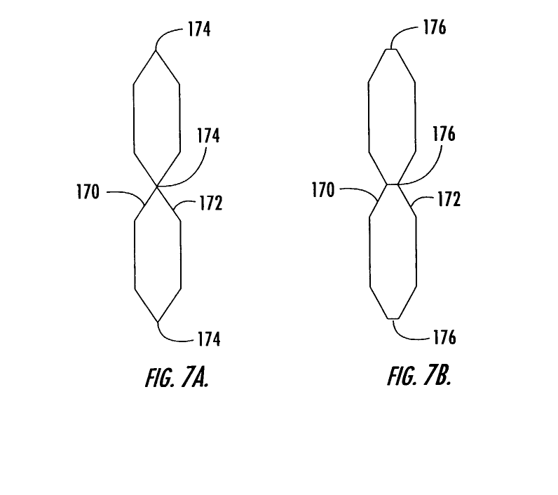

Follower section 54 may take many forms such as a simple flexible conduit but in one example also includes a plurality of similarly configured abutting links 150, 152, FIG. 6. As delineated above, steering cables 116, 118, 120, and 122 pass through links 150 and 152 as shown as do conduits 80, 82, and 84. The links of the follower section also include upper and lower tie cables 160, 162 extending therethrough terminating at one end at pivot member 56, FIG. 4 and terminating at the other end at steering mechanism 62.

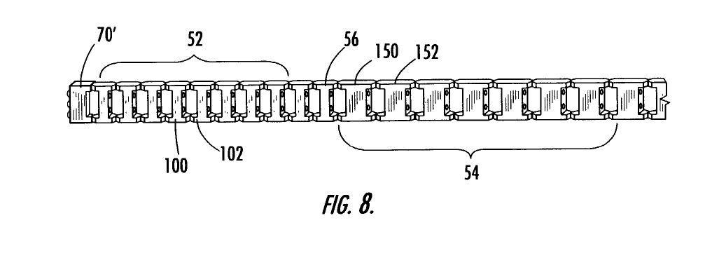

Thus, in one embodiment, steerable section 52, FIG. 7 includes a plurality of abutting links (e.g., links 100, 102) and follower section 54 also includes a plurality of links (e.g., links 150 and 152). Steering cables (e.g., cables 116, 118) begin at the steering mechanism (62, FIG. 4), pass slideably through the links of follower section 54, slideably through pivot link 56, slideably through the links of steerable section 52, and terminate at or are affixed to end effector 70. The tie cables (e.g., tie cable 160), in contrast, begin at the steering mechanism, run only through the links of follower section 54, and terminate or are fixed at pivot link 56. The tie cables secure the links of the follower section together and secure pivot link 56 to the distal end of follower section 54. In this way, the pivot point defmed by pivot member 56 need not be guided or supported by any external components in contrast to the various rail and transporter structures required of the prior art shown in FIGS. 1-3.

In various other embodiments there may be more or less steering cables and tie cables and separate tie cables securing the links of steerable section 52 together and the links of follower section 54 together. Preferably, all of the links have opposing tapered surfaces 170, 172 as shown for link 102 for better articulation between adjacent links.

In one example, steerable section 52, FIG. 4 is about 4½ inches long and comprises nine ½ inch long plastic links while follower section 54 is about 7½ feet long and comprises about one hundred one inch long plastic links. Pivot member 56 is a link the same size as the links of the steerable section but made of metal as is end effector 70. All of the links were about 1¾ inches tall but only about ⅜ inches wide. The result is a lengthy, slender, very strong, durable, universal, and versatile delivery system for positioning many different types of end effectors and/or tools into a position inside a complexly arranged machine or other devices or systems. Links can be added and removed fairly easily and quickly depending on the desired implementation. Also, the length of steerable section 52 can be adjusted to vary its effective bending radius. The size and number of links making up sections 52 and 54 will depend somewhat on the working environment and the configuration of end effector 70. The size and number of links making up steerable section 52 can also be varied in order to vary the effective bend radius. Additionally, varying the tension on the steering cables and tie cables allows variable flexibility of the overall system. Finally, the opposing tapered sections may meet at a point 174, or may form a flat surface 176 (see FIGS. 7A and 7B) of small or large dimension, in order to vary the flexibility of either the steerable section 52 or the follower section 54.

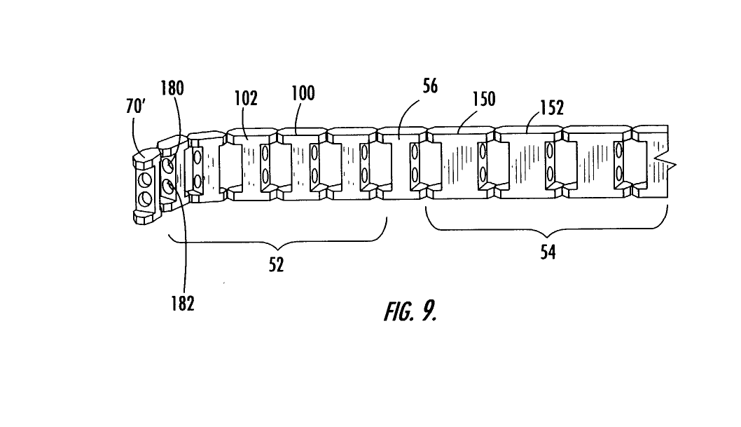

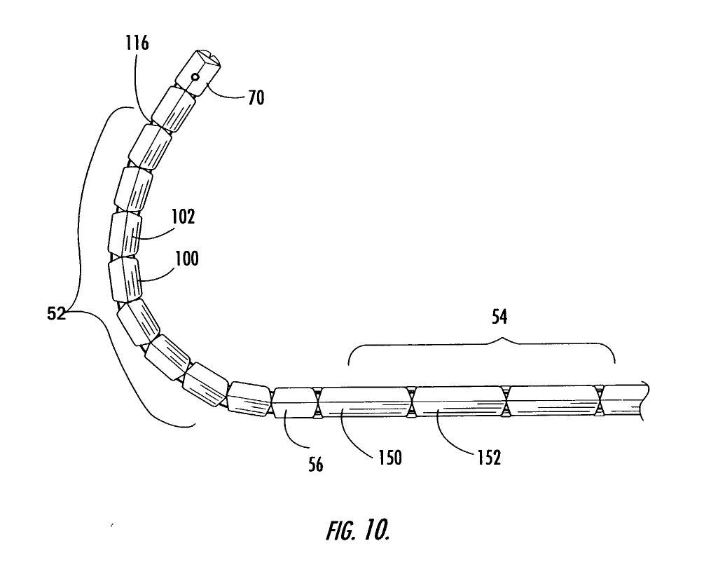

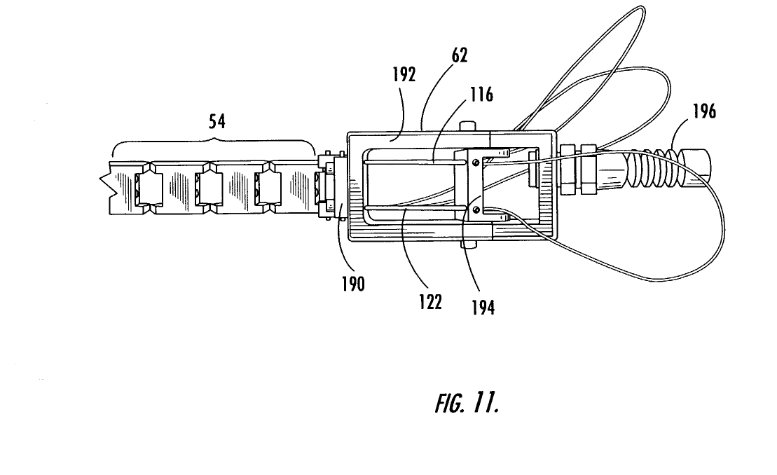

FIGS. 8-10 are additional depictions of this embodiment of the follower section and the steerable section in various configurations. FIG. 8 depicts how the design of pivot member 56 may be a link similar in construction to the other links as is the construction of end effector 70′. In FIG. 9, the conduits extending through the system are not in place but orifices 180, 182 are shown for accommodating the conduits. Also, end effector 70′ is shown before it is fitted with a video probe or probes and/or nozzles or tools. Steering cable 116 is visible in FIG. 10.

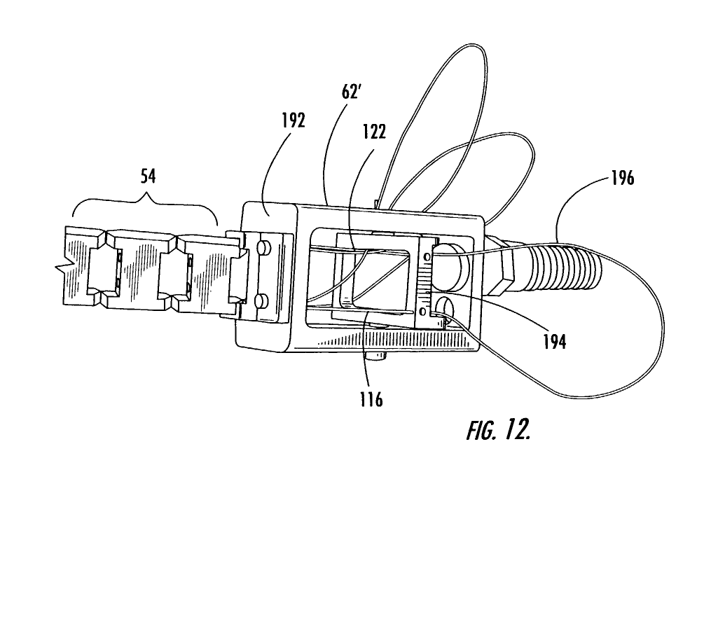

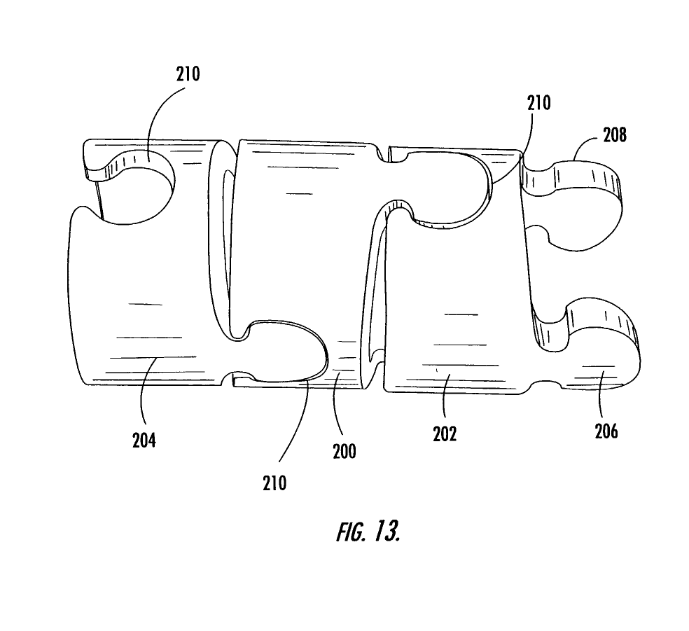

FIGS. 11-12 show, in one embodiment, steering mechanism 62′ coupled to the proximal end of follower section 54. At one end of the follower section 54, the tie cables are secured by block 190. The steering cables, however, extend slideably through frame 192 and are fixed to pivoting member 194 which rotates in one direction to pull cables 116 and 122 and which rotates in an opposite direction to pull cables 118, 120 (see FIG. 4). The various conduits of the system may extend outward through nipple 196. Pivoting member 194 may be manually operated but more typically is driven by an automatic mechanism (not shown). Those skilled in the art will understand that other steering mechanism designs are possible including joystick operated devices. Moreover, this invention is not limited to the use of cables to effect steering of steerable section 52, FIG. 4. In other alternative designs, bladders, pneumatic devices, hydraulic devices and the like could be employed.

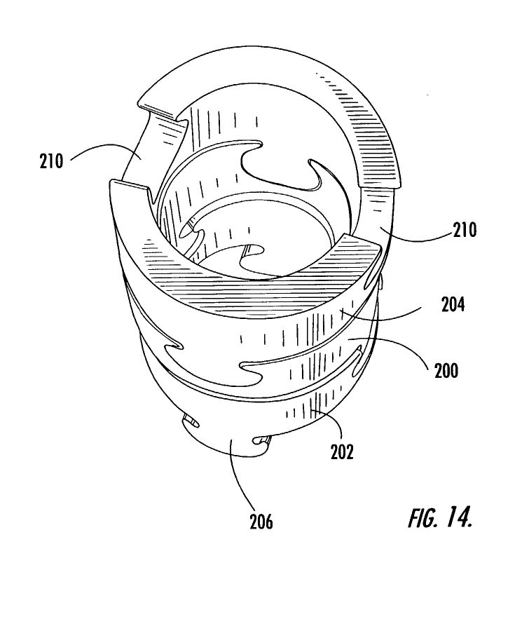

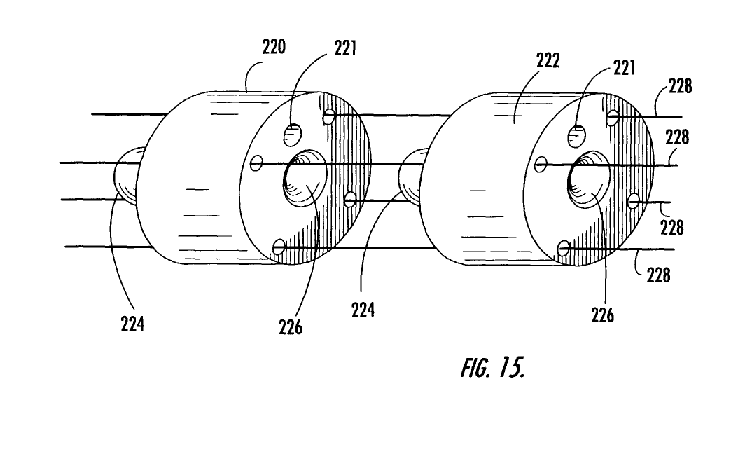

In the embodiment shown in FIGS. 13-15 the links of steerable section 52, FIG. 4 and/or the links of follower section 54 are configured in a ball and socket design. Each tube shaped link 200, 202, and 204, FIGS. 13-14 includes two opposing outwardly extending balls 206, 208 on one end as shown for link 202 and inwardly extending sockets 210 on the opposite end as shown for links 204, 200, and 202. The balls of each link are pivotably received in the sockets of each adjacent link as shown.

Preferably, the sockets are offset 90 degrees from the balls such that link 202 can pivot in and out of the page with respect to link 200, and, conversely, link 200 can pivot up and down with respect to link 204 (see also FIG. 13). In this way, if steerable section 52, FIG. 4 is configured as a plurality of links 202, 200, and 204, FIGS. 13-14, the steerable section can be flexed to steer right and left and also up and down via the steering cables which run through the links. In one example, there are four steering cables, one extending longitudinally through each ball and one extending longitudinally through each socket of each link. It is preferred that each pivotable link be configured as a tube shaped wall as shown so that conduits and the like can be positioned to extend inside each link. If follower section 54, FIG. 4 includes the link configuration of FIGS. 13-14, tie cables may be required.

Links 220, 222, FIG. 15, in contrast, are solid pieces each having a centrally located ball 224 and socket 226. Steering and optional tie cables 228 can be used to pivot the links with respect to each other to direct the device in many different directions. Orifice 221 extends longitudinally through each solid body link and can be used to receive therein, for example, a flexible conduit, rotating shaft, fiber optic cable, or the like. The links of FIG. 15 may form steerable section 52, FIG. 4 and/or follower section 54.

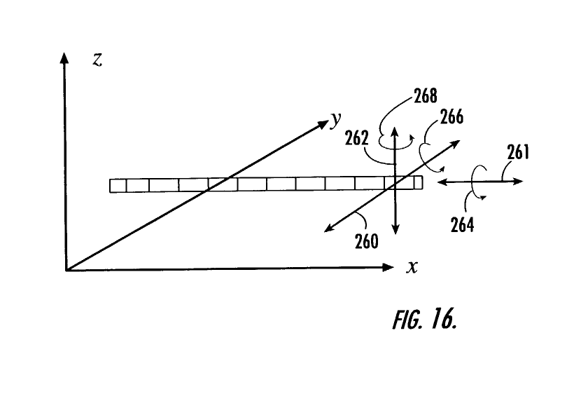

Depending on the configuration of the links of steerable section 52, many degrees of freedom are possible for the system of this invention. If the X axis of FIG. 16 is considered the longitudinal axis, then the steerable section can be urged (pushed) along that axis as shown by vector 261 since it is rigid along the longitudinal axis. As shown by vector 260, the design of FIGS. 4-12 can be steered in the direction of the Y axis, rotated 90 degrees, and then steered in the direction of the Z axis as shown by vector 262 (see FIGS. 9-10). By adding additional steering cables, the design of FIGS. 4-12 can even be steered in the direction of the Z axis without rotating it. In the design of FIGS. 13-15, additional degrees of freedom are possible including rotation about each axis as shown by vectors 264, 266, and 268, respectively.

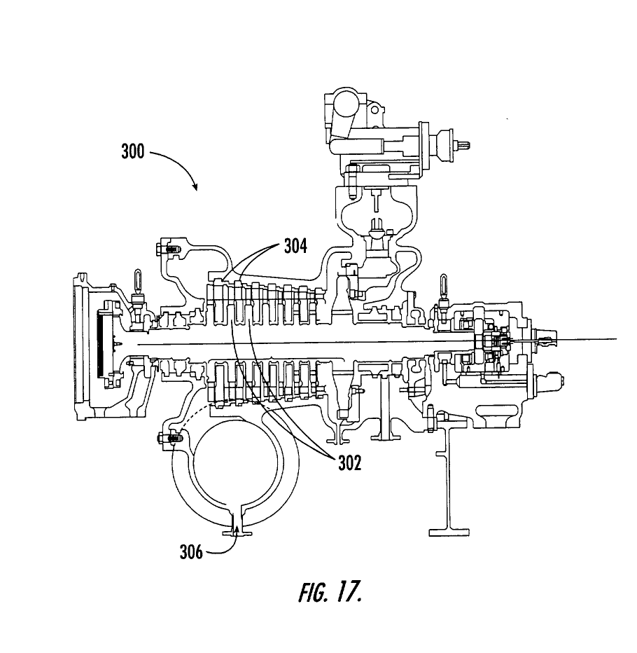

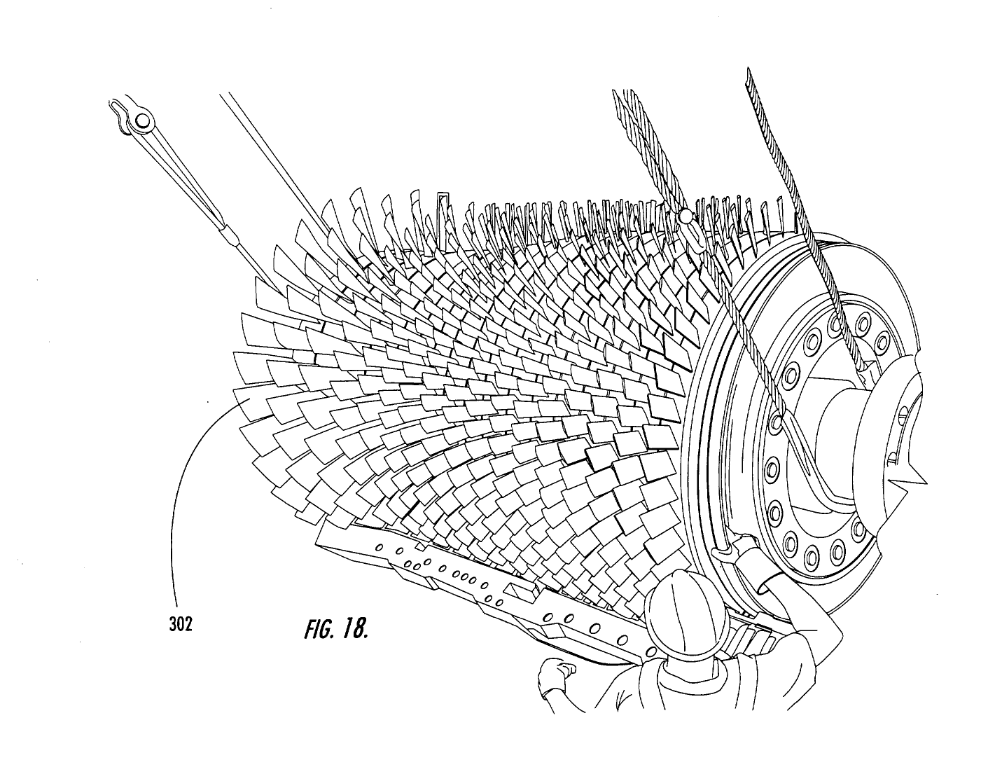

As shown in FIG. 17, turbine 300 includes many tightly packed internal components including rotor blades 302 interlaced with stator blades 304. Small access port 306 is located some distance from many of the internal blades. The complex geometry of the rotor and stator blades which must be inspected, cleaned, and repaired are more clearly shown in FIG. 18.

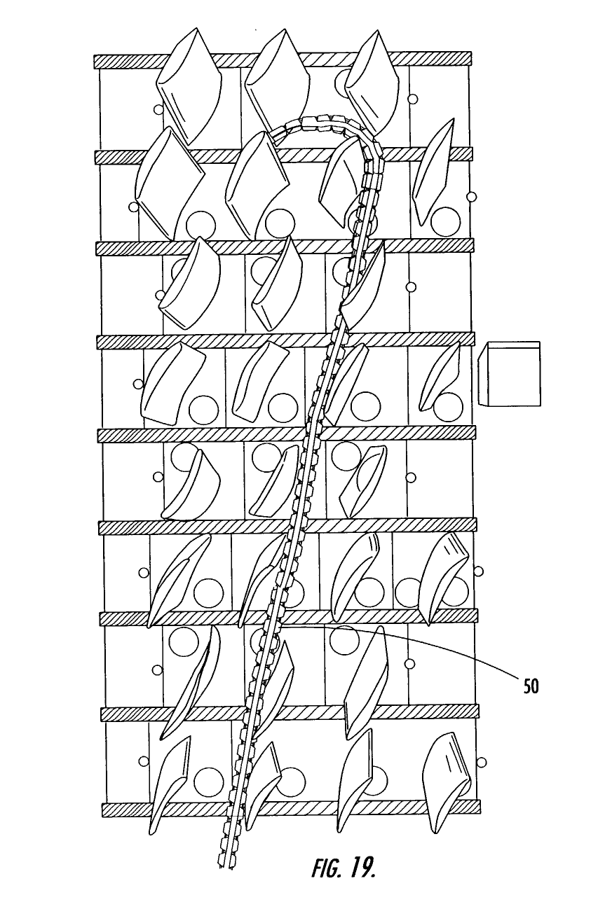

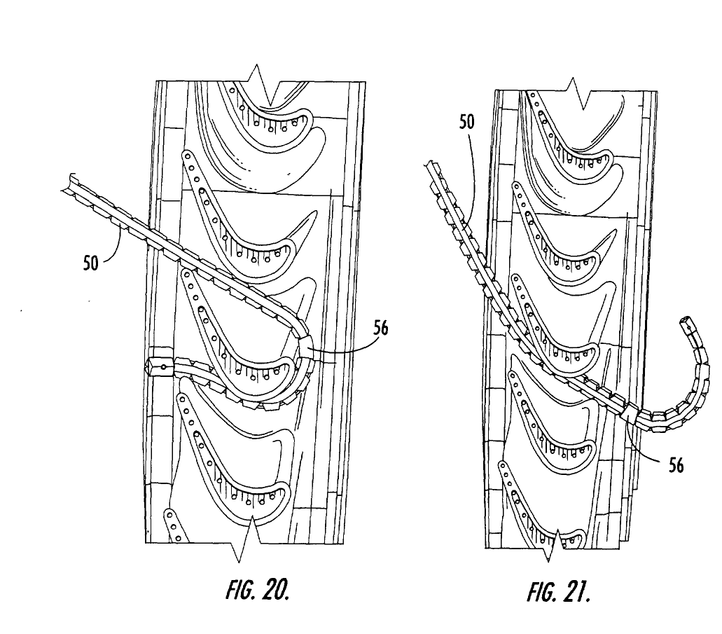

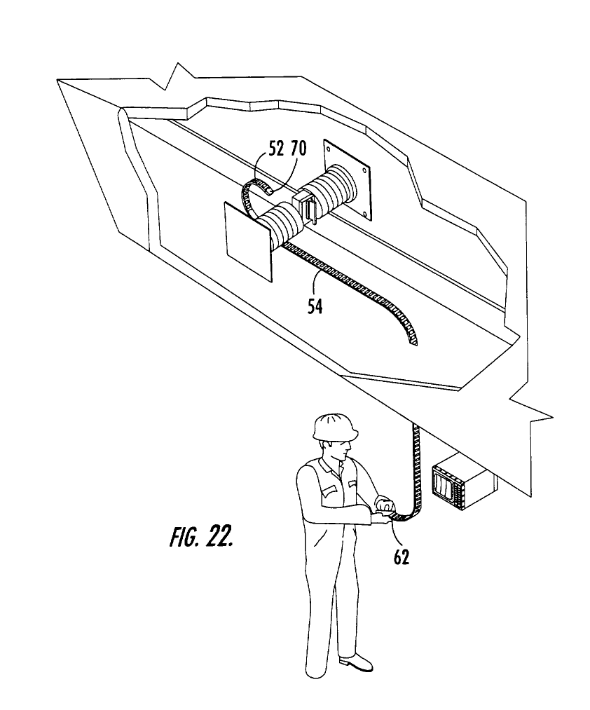

The unique steerable delivery system of the subject invention, however, can be remotely steered about, between, and even around the blades as shown in FIGS. 19-21. Thus, steerable system 50, FIG. 4, is useful for the inspection, maintenance and/or repair of various types of machinery including, but not limited to, gas turbines, steam turbines, and the like with difficult to access internal geometries. System 50 is fairly simple in design and easily manufacturable especially when plastic links and the cables discussed with reference to FIGS. 5-7 are employed. Typically, rigid rails and transporters are not required and system 50 can be extended many feet (e.g., 10 or more) into machinery irrespective of the complexity of the internal geometry thereof. Finally, system 50 is easily retracted from within the machinery. Steerable delivery system 50 typically includes steerable section 52 configured to be rigid along its longitudinal axis so it can be urged forward but flexible in one or more axes off-axis as shown in FIGS. 19-21, and is remotely steerable to advance between and around various internal machinery components as shown. Follower section 54, FIG. 4, located behind steerable section 52, is also rigid along its longitudinal axis but flexible off axis so that it too can bend to follow the path defined by steerable section 52 as shown in FIG. 21. Typically, follower section 54 is flexible in the same direction or directions as steerable section 52. Pivot mechanism or member 56, FIGS. 20 and 21 couples the steerable section to the follower section and is configured such that the steerable section pivots with respect to the pivot member. In this way, even the blades deep within a turbine or generator and far removed from an access port as shown in FIGS. 20 and 21 can be inspected, cleaned, and/or repaired since both the steerable section and the follower section can be advanced forward, the steerable section steered between and even about the blades as shown, and then the follower section advanced forward to follow the path of the steerable section.

In the preferred embodiment, steerable delivery system 50, FIG. 4 is comprised of a plurality of links (see FIGS. 5, 7-10, and 13-15). Each link includes one or more orifices therethrough for receiving a conduit as shown. Follower section 54, FIG. 4 is rigid along its longitudinal axis and flexible in at least one direction off-axis and may also include a plurality of similarly configured links (see FIGS. 6-10, and 13-15). Pivot mechanism 56, which may also be a link similar in design to the links of FIGS. 5 and 6, is disposed between the proximal end of steerable section 52, FIG. 4 and the distal end of follower section 54. In this way, the steerable section 52 is pivotable with respect to pivot mechanism 56.

A steering mechanism (see FIGS. 11-12) is typically disposed on the proximal end of follower section 54, FIG. 4 and there is at least one but typically more than one steering cable (see FIG. 7) extending from the steering mechanism, slideably through the follower section, the pivot mechanism, and the links of the steerable section and terminating at the distal end of the steerable section such as within end effector 70. In one embodiment, follower section 54, FIG. 4 also includes a plurality of links as shown in FIG. 6 and further included is one or more tie cables such as tie cable 160 and 162 extending from steering mechanism 62, FIG. 4, through the links of follower section 54 and terminating at pivot mechanism 56 (see FIG. 7).

The steerable delivery system of this invention, however, is not limited to the inspection, cleaning, or repair of turbines. As shown in FIG. 22, the embodiment of FIGS. 4-12 is shown in position for inspection in a metal clad bus. Other types of machinery which can be inspected, cleaned, or repaired in accordance with the subject invention include gas turbine engines, power steam turbines, auxiliary steam turbines, electric generators, compressors, chillers, pumps, blowers, electrical distribution systems, transformers, underground conduits, switch gear, circuit breakers, gear boxes and the like. Disassembly of such equipment is no longer required and thus the subject invention eliminates manhours and downtime costs associated with major equipment disassembly. Damage to the equipment during disassembly is also avoided as are reassembly errors which can create performance and operation problems. The steerable delivery system of the subject invention is capable of providing detailed visual inspection, measurement of critical component dimensions, gaps, and clearances, non-destructive examination including eddy current coating measurement and ultrasonic crack detection and measurement, foreign object retrieval, cleaning, coating and welding repair, grinding, and sampling.

Although specific features of the invention are shown in some drawings and not in others, however, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments. Other embodiments will occur to those skilled in the art and are within the following claims:

What is claimed is:

1. A steerable delivery system comprising:
a steerable section rigid along its longitudinal axis and flexible in at least one direction off-axis;
a follower section rigid along its longitudinal axis and flexible in at least the same direction as the steerable section, both the steerable section and the follower section advanceable in the direction of the longitudinal axis;
a pivot member disposed between a proximal end of the steerable section and a distal end of the follower section; and
a steering mechanism on the proximal end of the follower section for actively flexing the steerable section at the pivot member, and steering the steerable section in said one direction, the follower section flexing to follow the steerable section.

2. The system of claim 1 in which the distal end of the steerable section includes an end effector coupled thereto.

3. The system of claim 1 in which the steerable section includes a plurality of abutting links.

4. The system of claim 3 in which each steerable section link includes a plurality of cables therethrough terminating at a distal end of the steerable section for steering the steerable section.

5. The system of claim 3 in which each steerable section link includes at least one orifice for receiving a conduit, a transmission line, or a shaft therethrough.

6. The system of claim 3 in which each steerable section link includes upper inner and outer opposing faces, lower inner and outer opposing faces, and a central section interconnecting the upper opposing faces with the lower opposing faces.

7. The system of claim 6 in which the inner faces of each steerable section link abut the outer faces of each adjacent steerable section link.

8. The system of claim 6 in which each upper and lower face of each steerable section link includes at least one steering cable extending slideably therethrough and terminating on one end at a distal end of the steerable section, passing slideably through the pivot member and the follower section, and terminating at an opposite end at the steering mechanism.

9. The system of claim 1 in which the follower section includes a plurality of abutting links.

10. The system of claim 9 in which each follower section link includes a plurality of steering cables passing therethrough terminating at a distal end of the steerable section for steering the steerable section.

11. The system of claim 10 in which each follower section link also includes at least one tie cable extending therethrough terminating at one end at the pivot member and terminating at the other end at the steering mechanism.

12. The system of claim 9 in which each follower section link includes at least one orifice for receiving a conduit, a transmission line, or a shaft therethrough.

13. The system of claim 9 in which each follower section link includes upper inner and outer opposing faces, lower inner and outer opposing faces, and a central section interconnecting the upper opposing faces with the lower opposing faces.

14. The system of claim 13 in which the inner faces of each follower section link abut the outer faces of each adjacent follower section link.

15. The system of claim 13 in which the upper and lower faces of each follower section link include at least one steering cable extending slideably therethrough and terminating on one end at a distal end of the steerable section, passing slideably through the pivot member, and terminating at an opposite end at the steering mechanism.

16. The system of claim 15 in which the upper and lower faces of each follower section link further includes at least one tie cable extending therethrough terminating on one end at the pivot member and terminating on the other end at the steering mechanism.

17. The system of claim 3 in which each steerable section link includes upper and lower faces each having opposing tapered sections.

18. The system of claim 9 in which each follower section link includes upper and lower faces each having opposing tapered sections.

19. The system of claim 17 wherein the opposing tapered sections meet at a point.

20. The system of claim 18 wherein the opposing tapered sections meet at a point.

21. The system of claim 1 in which the steerable section and the follower section each include a plurality of abutting links, wherein all of the links include at least one steering cable passing slideably therethrough, the steering cable fixed on one end at a distal end of the steerable section and fixed on the opposite end at the steering mechanism, and further wherein at least the links of the follower section include at least on tie cable passing therethrough, the tie cable fixed on one end at the pivot member and fixed on an opposite end at the steering mechanism.

22. The system of claim 1 in which the steerable section includes a plurality of abutting links wherein the links of the steerable section include at least one steering cable passing slideably therethrough, the steering cable fixed on one end at a distal end of the steerable section, passing through the pivot member and the follower section, and fixed on an opposite end at the steering mechanism, the follower section further including at least one tie cable passing therethrough, the tie cable fixed on one end at the pivot member and fixed on an opposite end at the steering mechanism.

23. The system of claim 3 in which each steerable section link includes at least one ball and at least one socket and wherein the ball of one link is pivotably received in the socket of an adjacent link.

24. The system of claim 23 in which each steerable section link includes two opposing outwardly extending balls and two opposing inwardly extending sockets.

25. The system of claim 24 in which the sockets are offset from the balls.

26. The system of claim 24 in which the sockets are offset 90 degrees from the balls.

27. The system of claim 23 in which each steerable section link includes a tube shaped wall having outwardly extending balls on one end thereof and inwardly extending sockets in an opposite end thereof.

28. The system of claim 9 in which each follower section link includes at least one ball and at least one socket and wherein the ball of one link is pivotably received in the socket of an adjacent link.

29. The system of claim 28 in which each follower section link includes two opposing outwardly extending balls and two opposing inwardly extending sockets.

30. The system of claim 29 in which the sockets are offset from the balls.

31. The system of claim 30 in which the sockets are offset 90 degrees from the balls.

32. The system of claim 28 in which each follower section link includes a tube shaped wall having outwardly extending balls on one end thereof and inwardly extending sockets in an opposite end thereof.

33. The system of claim 2 in which end effector includes an optical device.

34. The system of claim 2 in which the end effector includes a nozzle.

35. The system of claim 2 in which the end effector includes a tool.

36. The system of claim 1 in which the length of the steerable section is much less than the length of the follower section.

37. The system of claim 1 in which the pivot member is connected to a distal end of the follower section.

38. A steerable delivery system comprising:
a steerable section having a distal end effector and including a plurality of links, each link including an orifice therethrough for receiving a conduit, transmission line, or a shaft connected to the end effector;
a follower section rigid along its longitudinal axis and flexible in an least one direction off-axis;
a pivot mechanism disposed between a proximal end of the steerable section and a distal end of the follower section, the steerable section pivotable with respect to the pivot mechanism;
a steering mechanism on a proximal end of the follower section; and
at least one steering cable extending from the steering mechanism through the follower section, the pivot mechanism, and the links of the steerable section and terminating at the distal end of the steerable section.

39. The system of claim 38 wherein the follower section also includes a plurality of links.

40. The system of claim 39 further including a tie cable extending from the steering mechanism, through the links of the follower section, and terminating at the pivot mechanism.

41. The system of claim 38 in which each steerable section link includes upper inner and outer opposing faces, lower inner and outer opposing faces, and a central section interconnecting the upper opposing faces with the lower opposing faces.

42. The system of claim 41 in which the inner faces of each steerable section link abut the outer faces of each adjacent said steerable section link.

43. The system of claim 42 in which the steering cable passes slideably through the upper or lower face of each link.

44. The system of claim 41 in which the central section of each steerable section link includes an orifice.

45. The system of claim 38 in which the follower section includes a plurality of abutting links.

46. The system of claim 45 in which each follower section ink includes the at least one steering cable passing therethrough.

47. The system of claim 46 in which each follower section link further includes at least one tie cable extending therethrough terminating at one end at the pivot member and fixed on the other end at the steering mechanism.

48. The system of claim 45 in which each follower section link includes at least one orifice for receiving a conduit, a transmission line, or a shaft therethrough.

49. The system of claim 46 in which each follower section link includes upper inner and outer opposing faces, lower inner and outer opposing faces, and a central section interconnecting the upper opposing faces with the lower opposing faces.

50. The system of claim 49 in which the inner opposing faces of each follower section link abut the outer opposing faces of each adjacent follower section link.

51. The system of claim 49 in which the steering cable extends through an upper or lower face of the follower section links.

52. The system of claim 49 in which an upper or lower face of each follower section link includes at least one tie cable extending therethrough terminating on one end at the pivot member and fixed on the other end at the steering mechanism.

53. The system of claim 38 in which each steerable section link includes upper and lower surfaces each having opposing tapered sections.

54. The system of claim 45 in which each follower section link includes upper and lower surfaces each having opposing tapered sections.

55. The system of claim 38 in which the follower section includes a plurality of abutting links, and wherein all of the links of the steerable section and the follower section include the at least one steering cable passing slideably therethrough, and further wherein the follower section links also include at least one tie cable passing therethrough, the tie cable terminating at one end at the pivot member and fixed on an opposite end at the steering mechanism.

56. The system of claim 38 in which each steerable section link includes at least one ball and at least one socket wherein the ball of one steerable section link is pivotably received in the socket of an adjacent steerable section link.

57. The system of claim 56 in which each steerable section link includes two opposing outwardly extending balls and two opposing inwardly extending sockets.

58. The system of claim 57 in which the sockets are offset from the balls.

59. The system of claim 58 in which the sockets are offset 90 degrees from the balls.

60. The system of claim 56 in which each steerable section link includes a tube shaped wall having outwardly extending balls on one end thereof and inwardly extending sockets in an opposite end thereof.

61. The system of claim 39 in which each follower section link includes at least one ball and at least one socket and wherein the ball of one follower section link is pivotably received in the socket of an adjacent follower section link.

62. The system of claim 61 in which each follower section link includes to opposing outwardly extending balls and two opposing inwardly extending balls.

63. The system of claim 62 in which the sockets are offset from the balls.

64. The system of claim 63 in which the sockets are offset 90 degrees from the balls.

65. The system of claim 39 in which each follower section link includes a tube shaped wall having outwardly extending balls on one end thereof and inwardly extending sockets in an opposite end thereof.

66. The system of claim 38 in which said distal end effector includes an optical device.

67. The system of claim 38 in which the distal end effector includes a nozzle.

68. The system of claim 38 in which the distal end effector includes a tool.

69. The system of claim 38 in which the length of the steerable section is much less than the length of the follower section.

70. The system of claim 38 in which the pivot member is connected to a distal end of the follower section.

71. A steerable delivery system comprising:
a steerable section having a distal end effector and including at least one orifice through the steerable section for receiving a conduit, transmission line, or a shaft;
a follower section including a plurality of links and configured to be rigid along its longitudinal axis and flexible in an least one direction off-axis;
a pivot mechanism disposed between the proximal end of the steerable section and the distal end of the follower section, the steerable section pivotable with respect to the pivot mechanism;
a steering mechanism on the proximal end of the follower section; and
at least one steering cable extending from the steering mechanism through the links of the follower section, the pivot mechanism, and the steerable section and terminating at the distal end of the steerable section.

72. The system of claim 71 wherein the steerable section also includes a plurality of links.

73. The system of claim 71 further including a tie cable extending from the steering mechanism, through the links of the follower section, and terminating at the pivot mechanism.
